(19) United States
(12) Patent Application Publication
(10) Pub. No.: US 2017/0257862 A1
(43) Pub. Date: Sep. 7, 2017

(54) Wireless Communication Enhancements for Relative Motion Between a Transmitting Device and a Receiving Device

(71) Applicant: QUALCOMM Incorporated, San Diego, CA (US)

(72) Inventors: Qi XUE, San Diego, CA (US); Peerapol Tinnakornsrisuphap, San Diego, CA (US)

(21) Appl. No.: 15/227,432

(22) Filed: Aug. 3, 2016

Related U.S. Application Data
(60) Provisional application No. 62/304,719, filed on Mar. 7, 2016.

(51) Int. Cl. H04W 72/04; H04B 7/185; H04W 72/08; H04L 12/26

(52) U.S. Cl. CPC H04W 72/0446; H04L 43/0847; H04B 7/18506; H04W 72/085

(57) ABSTRACT

A method, device, and system for managing wireless communications between a transmitting device and a receiving device including adjusting a size of a frame to be transmitted in response to determining that a potential degradation in reception of information within the frame to be transmitted due to relative motions of the transmitting device and the receiving device is likely to cause packet error rates of sub-frames within the frame to be transmitted to exceed a first packet error rate threshold value.

### RELATED APPLICATIONS

This application claims the benefit of priority to U.S. Provisional Patent Application 62/304,719 entitled “Wi-Fi Enhancements for Drone Wireless Data Links,” filed Mar. 7, 2016, the entire contents of which are incorporated herein by reference.

### BACKGROUND

Unmanned vehicles, such as unmanned aerial vehicles (UAVs), also referred to as “drones,” are used for photography and/or video surveillance. In many implementations, video captured by a camera in a UAV is transmitted in real time to a control unit operated by a user via a wireless data link. Some wireless local area network (WLAN) communication protocols, such as the Wi-Fi wireless communication protocol, provide a convenient wireless data link for UAVs given the common use of the technology, commercial availability of low cost transceivers, and suitability of the protocols for video content transmissions. However, WLAN communication protocol standards like the Wi-Fi wireless communication protocol standards, were developed for stationary access points and client devices, and do not include provisions for accommodating effects of Doppler frequency shifts experienced when there is relative motion between a transmitting device and a receiving device.

### SUMMARY

Various embodiments include methods, devices, and systems for managing wireless communications between a transmitting device and a receiving device based upon the relative motion between the two devices. Various embodiments may include determining whether a potential degradation in reception of information within a frame to be transmitted due to relative motion of the transmitting device and the receiving device will equal or exceed a first packet error rate threshold value and adjusting a size of the frame to be transmitted in response to determining that the potential degradation in the reception of information within the frame to be transmitted will equal or exceed the first packet error rate threshold value.

In some embodiments, adjusting the size of the frame to be transmitted may include reducing a number of sub-frames included within the frame. In some embodiments, adjusting the size of the frame to be transmitted may include reducing a size of sub-frames included within the frame. In some embodiments, adjusting the size of the frame to be transmitted may include setting the size of the frame to be transmitted using information obtained from a data table in memory.

Some embodiments may further include determining whether packet error rates of an end portion of a previously transmitted frame are greater than a second packet error rate threshold value, in which adjusting the size of the frame to be transmitted may include reducing the size of the frame to be transmitted in response to determining that the packet error rates of the end portion of the previously transmitted frame are greater than the second packet error rate threshold value.

Some embodiments may include determining whether the packet error rates of sub-frames within an end portion of a previously transmitted frame are less than or equal to a third packet error rate threshold value, in which adjusting the size of the frame to be transmitted includes increasing the size of the frame to be transmitted in response to determining that the packet error rates of the end portion of the previously transmitted frame are less than or equal to the third packet error rate threshold value.

In some embodiments, the wireless communications may be Wi-Fi transmissions, in which the frame to be transmitted may be an aggregated media access control packet data unit (AMPDU) including a number of media access control packet data units (MPDUs), and adjusting the size of the frame to be transmitted may include reducing or increasing at least one of a number or a size of MPDUs in the AMPDU.

Some embodiments may include determining whether packet error rates of MPDUs within an end portion of a previously transmitted AMPDU are greater than a second packet error rate threshold value may be determined, in which adjusting the size of the frame to be transmitted may include reducing the size of the frame to be transmitted in response to determining that the packet error rates of the MPDUs within the end portion of the previously transmitted AMPDU are greater than the second packet error rate threshold value.

Some embodiments may include determining whether packet error rates of MPDUs within an end portion of a previously transmitted AMPDU are less than or equal to a third packet error rate threshold value. In addition, adjusting the size of the frame to be transmitted may include increasing at least one of the number or the size of the MPDUs in the AMPDU to be transmitted in response to determining that the packet error rates of the MPDUs within the end portion of the previously transmitted AMPDU equal or do not exceed a third packet error rate threshold value.

In some embodiments, determining whether the potential degradation in the reception of information within the frame to be transmitted due to the relative motion of the transmitting device and the receiving device will equal or exceed the first packet error rate threshold value may include calculating a Doppler velocity between the transmitting device and the receiving device based upon a position of the receiving device that is stationary, a position of the transmitting device, and a velocity vector of the transmitting device.

In some embodiments, determining whether the potential degradation in the reception of information within the frame to be transmitted due to the relative motion of the transmitting device and the receiving device will equal or exceed the first packet error rate threshold value may include calculating a Doppler velocity between the transmitting device and the receiving device based upon a position of the transmitting device that is stationary, a position of the receiving device, and a velocity vector of the receiving device.

In some embodiments, determining whether the potential degradation in the reception of information within the frame to be transmitted due to the relative motion of the transmitting device and the receiving device will equal or exceed the first packet error rate threshold value may include calculating a Doppler velocity between the transmitting device and the receiving device based upon a position and a velocity vector of the transmitting device and a position and a velocity vector of the receiving device, in which both the transmitting device and the receiving device are moving independently of one another.

Some embodiments may include calculating a distance between the transmitting device and the receiving device based upon a position of the transmitting device and a position of the receiving device, estimating a signal to noise ratio based on the calculated distance, and using the estimated signal to noise ratio to select a modulation and coding scheme (MCS) value to use in the frame to be transmitted.

Some embodiments may include calculating a distance between the transmitting device and the receiving device, determining a relative speed between the transmitting device and the receiving device, determining whether an operating frequency band of the wireless communications between the transmitting device and the receiving device is set to a first predetermined value, and changing the operating frequency band to a second predetermined value in response to the calculated distance between the transmitting device and the receiving device being less than a threshold distance, the determined relative speed being less than or equal to a threshold speed, and the determined operating frequency band is set to the first predetermined value.

Some embodiment may include calculating a distance between the transmitting device and the receiving device, determining a relative speed between the transmitting device and the receiving device, determining whether an operating frequency band of the wireless communications between the transmitting device and the receiving device is set to a first predetermined value, and changing the operating frequency band to a second predetermined value in response to the calculated distance between the transmitting device and the receiving device being greater than a threshold distance and the determined operating frequency band being set to the first predetermined value.

In some embodiments, determining whether the potential degradation in the reception of information within the frame to be transmitted due to the relative motion of the transmitting device and the receiving device will equal or exceed the first packet error rate threshold value may include comparing a relative speed between the transmitting device and the receiving device to a speed threshold value, and determining that the potential degradation in the reception of information within the frame to be transmitted will equal or exceed the first packet error rate threshold value in response to the speed of the transmitting device exceeding the threshold. The speed threshold value may depend on an operating frequency band of the wireless communications between the transmitting device and the receiving device.

In some embodiments, adjusting the size of the frame to be transmitted may include setting the size of the frame at a value determined by using a relative speed between the transmitting device and the receiving device to perform a look up in a table of transmission frames sizes correlated to relative speeds between the transmitting device and the receiving device, and changing an operating frequency band to a first predetermined value in response to the relative speed not being in the table and the operating frequency band being a second predetermined value.

Some embodiments may include determining, from one or more accelerometers on the transmitting device, an acceleration of the transmitting device, adjusting an aggregated media access control packet data unit (AMPDU) in response to determining that acceleration of the transmitting device exceeds an acceleration threshold value. An acceleration of the transmitting device may be determined from one or more accelerometers on the transmitting device. Some embodiments may include adjusting the size of the frame to be transmitted in response to determining that acceleration of the transmitting device exceeds an acceleration threshold value.

Some embodiments may include determining whether the size of the frame to be transmitted is a minimum value and whether the wireless communications between the transmitting device and the receiving device are set to a first operating frequency band value, and changing an operating frequency band of the wireless communications to a second operating frequency band value in response to the size of the frame to be transmitted being the minimum value and the wireless communications being set to the first operating frequency band value.

Some embodiments include a UAV having a radio module and a processor configured to perform operations of the methods summarized above. Some embodiments include a receiving device having a radio module and a processor configured to perform operations of the methods summarized above.

Further embodiments include radio modules having means for performing functions of the methods summarized above. Further embodiments include a non-transitory processor-readable storage medium having stored thereon processor-executable instructions configured to cause a processor to perform operations of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a schematic perspective view of a UAV and a controller illustrating changes in the Doppler velocity observed from relative motion.

FIG. 2A is an illustration of a wireless sequence according to various embodiments.

FIG. 2B is an illustration of a media access control (MAC) layer packet data unit of a wireless protocol according to various embodiments.

FIG. 3A is a graph illustrating packet error rates as a function of signal-to-noise ratio of the various MAC layer data packet units within a wireless communication frame when the receiving device and transmitting device are relatively still.

FIG. 3B is a graph illustrating packet error rates is a function of signal-to-noise ratio of various MAC layer data packet units within the wireless communication frame when the transmitting device is relatively still with respect to the receiving radio module.

FIG. 4A is a graph illustrating packet error rates for various modulation and coding scheme (MCS) values as a function of signal-to-noise ratio when the transmitting radio module is moving at 25 kilometers per hour with respect to the receiving radio module and the MPDU size is 1500 bytes.

FIG. 4B is a graph illustrating packet error rates for various modulation and coding scheme (MCS) values as a function of signal-to-noise ratio when the transmitting radio module is moving at 25 kilometers per hour with respect to the receiving radio module and the MPDU size is 300 bytes.

FIG. 5 is a component block diagram of a UAV including command-and-control components suitable for use with various embodiments.

FIG. 6 is a process flow block diagram of a UAV control device suitable for use with various embodiments.

FIG. 7A is a process flow diagram of a method of managing frame size and modulation schemes for wireless communications link when the transmitting device is moving with respect to the receiving device according to various embodiments.

FIG. 7B is a process flow diagram illustrating a method of adjusting the frame size of a wireless communications link based on packet error rates when the transmitting device is moving with respect to the receiving device according to some embodiments.

FIG. 7C is a process flow diagram illustrating a method of adjusting the frame size of a wireless communications link based on packet error rates and relative accelerations of the transmitting device when the transmitting device is moving with respect to the receiving device according to some embodiments.

FIG. 8 is a process flow diagram illustrating a method of managing frame size and MCS values based on packet rates and signal-to-noise ratio according to some embodiments.

FIG. 9A is an illustration of a UAV moving relative to a control device illustrating the dynamic nature of the Doppler velocity between the transmitting device and receiving device affects when the transmitting device is moving at a constant speed and direction.

FIG. 9B is a graph illustrating how the rate of change in the Doppler velocity depends upon the distance to the closest approach when the transfer device travels past the receiving device.

FIG. 10 is a graph illustrating how speed can affect changes in the Doppler velocity when the transfer device is maneuvering through a 90° turn.

FIG. 11 is a process flow diagram illustrating a method of managing frame size and MCS values based on calculations of the location and direction of travel of the transmitting device relative to the receiving device all according to some embodiments.

FIG. 12 is a process flow diagram illustrating a method of managing frame size and MCS values based on calculations of the location and direction of travel of the transmitting device relative to the receiving device plus accelerations of the transmitting device according to some embodiments.

FIG. 13 is a process flow diagram illustrating a method of managing frame size and MCS values based on a travel speed of the transmitting device relative to the receiving device all according to some embodiments.

FIG. 14 is a process flow diagram illustrating a method of managing a frequency used for communications based on a separation distance and relative speed between a transmitting device and a receiving device according to some embodiments.

FIG. 15 is a process flow diagram illustrating another method of managing a frequency used for communications based on a separation distance and relative speed between a transmitting device and a receiving device according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and communication devices implementing the methods for improving data communications when a transmitting device is moving with respect to a receiving device. The various embodiments may be particularly useful for WLAN communications, such as those using a protocol like Wi-Fi communications that was developed for relatively stationary access points and client devices. When the transmitting device is moving relative to the receiving device, the Doppler shift in frequency caused by such relative movement can interfere with reception of some data packets. For example, testing has revealed that when a UAV, which is using Wi-Fi to transmit video to a receiving radio module (e.g., a controller), is moving at significant speeds, the Doppler effect can impact the channel estimate due to degradation in a reception of information within a frame. A preamble, establishing the channel synchronization and channel estimate for a frame, is transmitted at the beginning of the frame. The longer the time since the preamble was transmitted, the higher the packet error rate observed by a stationary receiving device. A few tens of miles per hour or more may be considered significant speeds at which Media access control Protocol Data Units (MPDUs) from UAV Wi-Fi transmissions that are transmitted late in a frame (referred to as Aggregate MPDU (AMPDU)) may exhibit high packet error rates. Thus, determining a potential degradation that may cause threshold packet error rates may be considered sufficient degradation in the reception of information within a frame to warrant adjusting a size of the frame to be transmitted.

Various embodiments provide methods for adjusting the frame size (i.e., AMPDU size in Wi-Fi communication links) or size of sub-frames (i.e., sets of consecutive MPDUs within an AMPDU in Wi-Fi communication links) as well as the Modulation and Coding Scheme (MCS) value to mitigate the effects of Doppler shifts in communication link frequencies caused by the relative motion of the transmitting device with respect to the receiving device. In some embodiments, the frame size (AMPDU size in Wi-Fi communication links) may be adjusted based on observed packet error rates in sub-packets in the end portion of the frame. In some embodiments, the MCS value and sub-frame size (i.e., MPDU size) may be adjusted based on adjustments to the frame size and signal-to-noise ratio to improve the overall data transmission rate. In some embodiments, the frame size (e.g., AMPDU size) may be adjusted based upon an estimate of the Doppler velocity calculated using the position and velocity vector of the transmitting device and the position of the receiving device. In some embodiments, the frame size may be further adjusted based on a measured speed of the transmitting radio module. In some embodiments, the frame size, MCS value, and sub-frame size may be further adjusted based on measured accelerations of the transmitting radio module.

In many applications for the various embodiments, data and command information is communicated between two or more devices, which may take turns transmitting and receiving communications via the wireless communication link. Thus, at a first time a first device transmitting data or command signals (and thus functioning as the transmitting device) may be received at a second time by a second device receiving the data or command signals (and thus function as the receiving device). Various embodiments involve methods that may be implemented in a device that is transmitting to enable another device that is receiving to recover the transmitted data more reliably when either or both of the devices are moving relative to one another. Therefore, for the sake of brevity, the device that is implementing an embodiment while transmitting signals is referred to herein as either the “transmitting device” or a “transmitting radio module” while the other device is referred to herein as the “receiving device” or a “receiving radio module.”

In many circumstances, devices using a wireless communication link may alternatively transmit and receive signals via a radio module, thus the terms transmitting device and receiving device are not intended to limit the description or the claims to devices or radio modules that only transmit or receive. As a useful example implementation, various embodiments are described using a UAV as the transmitting device and a ground based controller as the receiving device. However, this is for illustration purposes only. It should be understood that in this example when the controller is transmitting (i.e., acting as a transmitting device), the same Doppler-induced reception problem exists in the UAV acting as the receiving device. Thus, the various embodiments may be implemented in both moving and stationary devices using wireless communications. Thus, references to the transmitting device or transmitting radio module, as well as the receiving device or receiving radio module, are not intended to limit the scope of the claims to a particular one or type of device unless specifically recited in the claims.

As used herein, the term “UAV” refers to one of various types of unmanned aerial vehicles. UAVs are used as an example of an autonomous or remotely controlled vehicle that may benefit from various embodiments. However, the claims and the description are not limited to unmanned aerial vehicles and may be used in air, land, sea, space, or a combination thereof as autonomously or remotely controlled vehicles when traveling at speeds relative to a base unit that cause Doppler frequency shifts to degrade wireless communications as described herein. Therefore, the use of UAVs as example embodiments for purposes of describing problems addressed and solutions provided by the claims are not intended to limit the scope of the claims unless specifically recited in claim elements.

As used herein, the term “controller” refers generally to a relatively stationary receiver of wireless transmissions from a UAV, an example which is a user interface that includes user input devices (e.g., a joystick), a display for displaying imagery received from the UAV, and a wireless transceiver for sending commands to the UAV and receiving data, such as video data packets, from the UAV. The various embodiments may be used in any wireless communication situation in which the transmitter of data packets is moving relative to the receiver of the data packets at speeds at which Doppler effects may cause degradation in the reception of information within a frame to be transmitted and impact the communication link. Thus, the claims are not limited to situations in which the receiving device is a remote control interface unless specifically recited in the claims. Thus, the term “controller” is meant to encompass fixed or nearly stationary receivers of wireless data signals from a UAV that do not provide control commands to the UAV.

As used herein, the term “computing device” refers to an electronic device equipped with at least a processor. Examples of computing devices include processors within a controller and the UAV flight control and/or mission management computer that are onboard the UAV, as well as remote computing devices communicating with the UAV configured to perform operations of the various embodiments. Computing devices implemented in base units may include wireless communication devices (e.g., cellular telephones, wearable devices, smart-phones, web-pads, tablet computers, Internet enabled cellular telephones, Wi-Fi® enabled electronic devices, personal data assistants (PDA's), laptop computers, etc.), personal computers, and servers. In various embodiments, computing devices may be configured with memory and/or storage. Additionally, computing devices referred to in the various example embodiments may be coupled to or include wireless communication capabilities implementing various embodiments, such as network transceiver(s) and antenna(s) configured to establish a local area network (LAN) connection (e.g., Wi-Fi® transceivers).

As used herein, the term “Doppler velocity” (V_{Doppler} or V_{D} in the drawings) refers to the relative velocity of a transmitting device, such as a UAV, with respect to the receiving device, such as a controller, along the direct line between the two devices. Thus, the amount of Doppler shift observed by the receiving device will be based on the Doppler velocity, which may differ from the actual speed of the transmitting device.

Wi-Fi is a useful wireless communication protocol to use for transmitting data, including video data, from UAVs to a receiving unit, such as a controller, as well as for uplink and commands for guiding the UAV. Wi-Fi is a well-known protocol, with standards set for media access control (MAC) and physical layer (PHY) specifications for implementing WLAN. In addition, transceivers and other components for implementing Wi-Fi communications are readily available and affordable. However, the Wi-Fi communication protocol demonstrates high packet error rates when the transmitting device is moving at a relatively high speed (such as tens of miles per hour) with respect to the receiving device due to effects of the Doppler frequency shift. Such possibilities are due in part to the frame structure of the Wi-Fi protocol.

As used herein, the term “frame” refers to a digital unit of transmission in computer networking and telecommunications. The frame may hold data that includes a preamble in the header portion followed by a data portion made up of a number of data packets referred to as MPDUs. The preamble includes a sequence of symbols that enable the receiving radio module to recognize the start of the frame, the size or end of the frame, and synchronize the receiving radio module with the data symbols within the frame. The header portion enables the receiving radio module to obtain information regarding the modulation and coding scheme (MCS) used in the data portion, as well as the length or number of packets (i.e., MPDUs) or sub-frames (i.e., groups of MPDUs forming an AMPDU) in the data portion. Some implementations of Wi-Fi (e.g., 802.11ac) include a sequence of symbols in the preamble that enable the receiver of the packet to obtain a channel estimate and conduct multiple in multiple out (MIMO) training. The timing and frequency synchronization and channel estimation symbols of the preamble and header portion enabled the receiver of the frame to recognize and extract the sub-packets within the data portion. Essentially, the frame preamble establishes the physical layer (abbreviated as “PHY”) details of modulation, coding, and synchronization used to transmit the MAC layer data packets that are included in the data portion of the frame.

Because the synchronization and channel estimations symbols are included in the preamble of the frame, the receiving radio module uses that information to receive all of the sub-packets that follow within the frame. If the frequencies and/or timing of symbols received by the receiving radio module changes during the period that the frame is received, the packets or sub-frames near the end of the frame may experience degradation, such as high packet error rates. This is what happens when the transmitting radio module is traveling at significant speeds relative to the receiving radio module due to Doppler shifts in the received wireless signals.

The various embodiments may overcome problems introduced by the Doppler velocity effects by shortening the length of the frame, such as by reducing the number of packets or sub-frames included within a frame. Reducing the number of sub-frames following the preamble of the frame minimizes the impact (i.e., the potential degradation) on communications of shifting channel conditions caused by Doppler effects. Further improvements are provided by adjusting the size (i.e. number of bytes) of each sub-frame, which may enable trading off the type and amount of modulation and coding (i.e., the MCS value) used in the MPDU against the size of the sub-frame to achieve an improved data transmission rate.

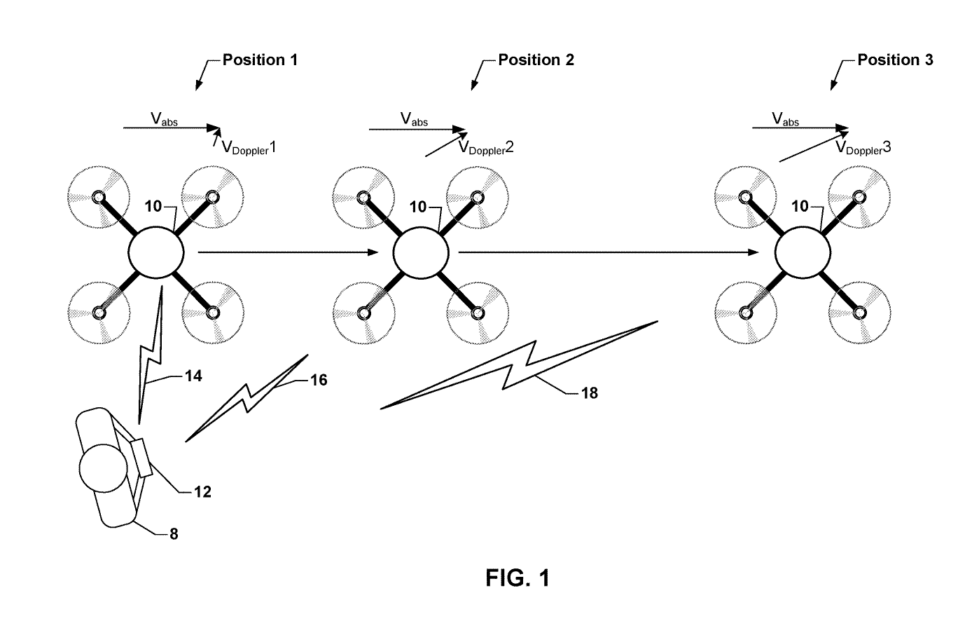

FIG. 1 illustrates a problem that may occur from degradation in radio frequency (RF) communications due to a fast traveling transmitting device, such as a UAV 10, transmitting to a receiving device 12, such as a controller (and vice versa because the Doppler velocity is a function of the relative motion of the two devices). Generally, the receiving device 12 is stationary, otherwise the velocity and position of the UAV 10 may be determined relative to the velocity and/or position of the receiving device 12. FIG. 1 illustrates the UAV 10 traveling at a velocity V_{abs} past a user 8 holding the receiving device 12. As the UAV 10 passes the user 8 at Position 1, a first Doppler velocity (V_{Doppler}1) may be zero or nearly zero as the component of the UAV velocity vector in the direction of the receiving device 12 is small. A very short time later, if the UAV 10 is traveling at tens of miles per hour, the UAV 10 will reach Position 2 where a second Doppler velocity (V_{Doppler}2), corresponding to the component of the UAV velocity vector in the direction of the receiving device 12, is significantly greater than the first Doppler velocity. Thus, during the short time that the UAV 10 takes to travel from Position 1 to Position 2, the Doppler velocity changes significantly, appearing to exhibit high acceleration even though the UAV 10 is traveling in a straight line at a constant speed. Consequently, the channel conditions are changing rapidly between Positions 1 and 2. Thus, a channel estimate determined by the receiving device 12 for first wireless signals 14, which is received when the UAV 10 transmitting the first wireless signals 14 was at Position 1, may be invalid for the second wireless signals 16, which is received when the UAV 10 is at Position 2. As the UAV 10 continues to travel to Position 3, the Doppler velocity continues to increase to a third Doppler velocity (V_{Doppler}3), but at a decreasing rate of change. Thus, the rate of change in the channel characteristics of the third wireless signals 18 will be reduced as the distance between the UAV 10 and the receiving device 12 increases in the fly-by scenario. Thus, Doppler affects caused by the speed of the UAV 10 are dynamic based upon relative speeds, directions, and positions of the UAV 10 and the receiving device 12. Consequently, a static correction for Doppler affects may be overly conservative for one frame and excessively aggressive for the next.

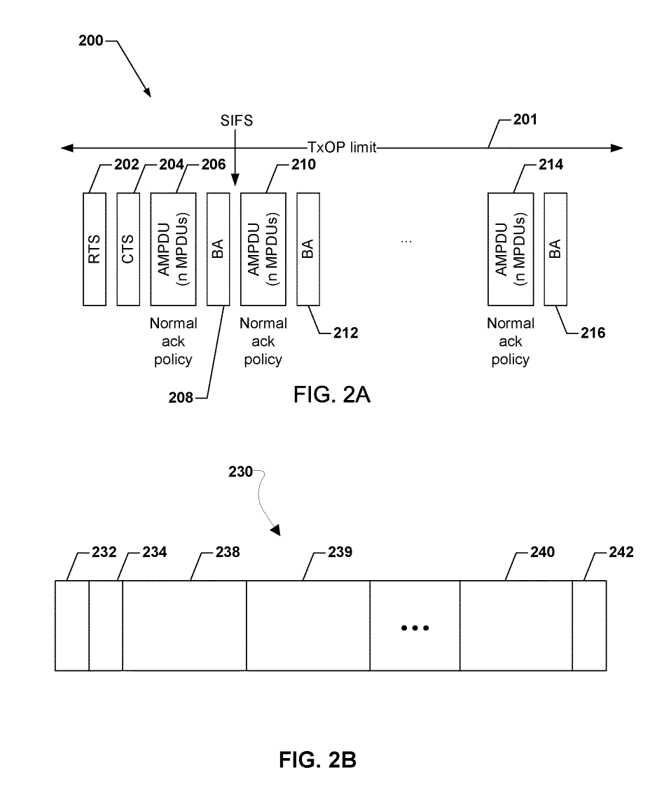

FIG. 2A illustrates a communication burst 200 for a Wi-Fi data transmission according to various embodiments. A communication session may begin by a radio module in the transmitting device (e.g., UAV 10) transmitting a request to send (RTS) frame 202 followed by a clear to send (CTS) frame 204. The effect of these transmissions is to create a set time limit, referred to as a transparent opportunity (TxOP) limit 201, during which the transmitting radio module has the right to initiate frame exchange sequences onto the wireless medium. The transmitting radio module may then transmit a sequence of frames (i.e., AMPDUs) 206, 210, 214 within the TxOP limit 201. Each frame 206, 210, 214 may be made up of a number (n) of sub-frames (i.e., MPDUs) carrying the data being transmitted. The number n of packets or sub-frames within each frame may vary, as indicated in the header portion of each frame.

After each frame, the transmitting radio module may wait to receive a block acknowledgment (BA) 208, 212, 216 from the receiving radio module. The block acknowledgments may include information regarding the packet errors (e.g., one or more packet error rate values) within each frame that were detected by the receiving radio module. The next frame may be transmitted a short time after receiving the block acknowledgment, indicated as a short inter-frame space (SIFS), in order to reduce the channel access overhead.

FIG. 2B illustrates components of a frame 230 (e.g., an AMPDU). Each frame 230 may begin with a preamble 232 and a MAC header 234 that provide the synchronization and channel estimate symbols, as well as the MCS value and number of packets (e.g., MPDUs) or sub-frames that the receiving radio module requires to recognize and decode the data packets that follow. A number of sub-frames 238, 239, 240 may then follow the preamble 232 and MAC header 234. Finally, symbols 242 indicating the end of the frame 230 may be included. A receiving radio module (e.g., a radio module in a receiving device 12), which may receive one or more trailing sub-frames, such as sub-frame 240 transmitted near the end of the frame 230, must rely on the single set of synchronization and channel estimate symbols transmitted in the preamble 232, which is disposed at the very beginning of the frame 230.

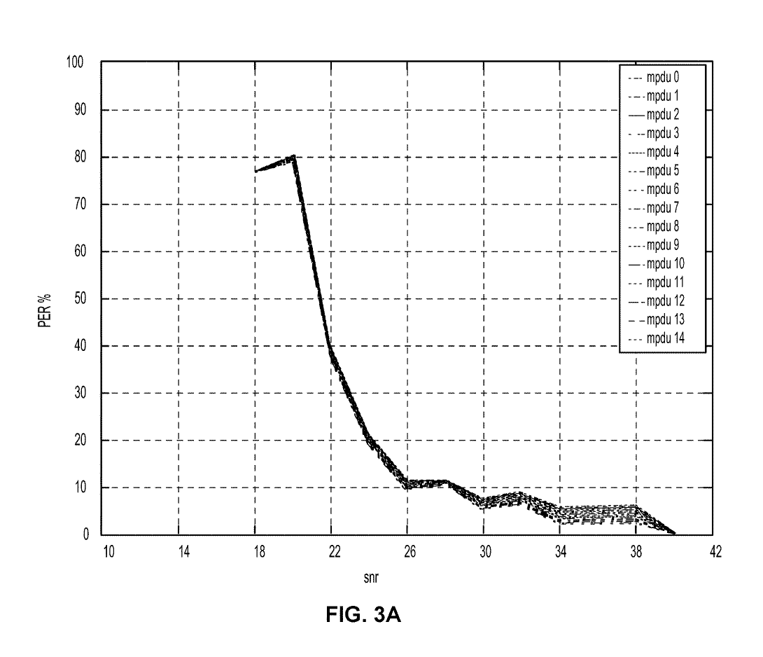

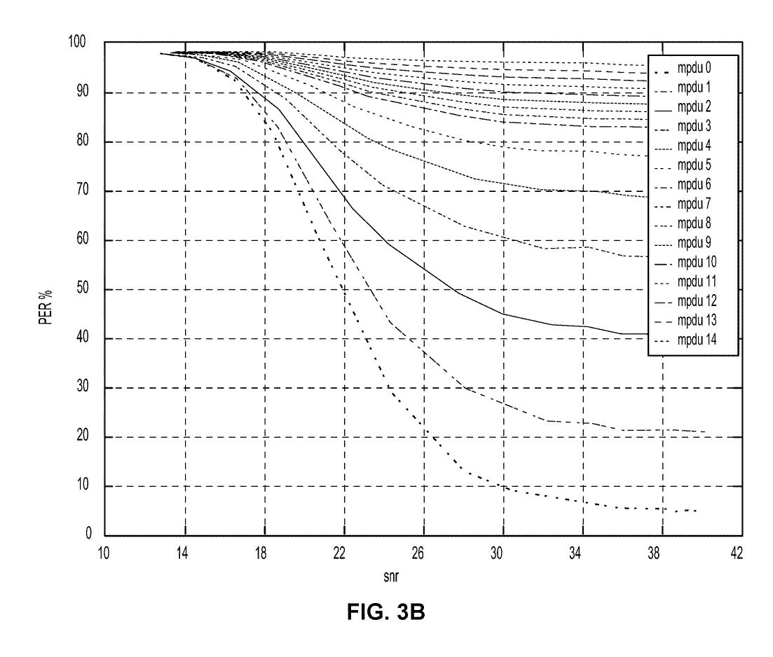

A problem caused by movement of the transmitting device relative to the receiving device is illustrated in FIGS. 3A and 3B. FIG. 3A illustrates a plot of packet error rate (PER) percentages for each of 15 different MPDUs in an AMPDU, as a function of signal-to-noise ratio (snr) when the transmitter, receiver, or both are at rest with respect to one another. As the graph in FIG. 3A illustrates, the packet error rate may vary little from the first MPDU (e.g., MPDU-0) to the last (e.g., MPDU-14). In contrast, as illustrated in FIG. 3B, when the transmitting device, such as a UAV 10 (FIG. 1), is moving at 25 km/h relative to the receiving device, such as the receiving device 12 (FIG. 1), the packet error rate of the first MPDU (e.g., MPDU-0) in the AMPDU may be significantly better than the trailing MDPUs (i.e., near the end of the AMPDU, such as MPDUs 11-14), which may experience error rates exceeding 90%. Thus, a relative speed of 25 km/h may result in degradation in a reception of information within a frame to be transmitted due to the relative motions of the transmitting device and the receiving device. Such degradation may prevent the receiving radio module from receiving the majority of packets or sub-frames within a frame.

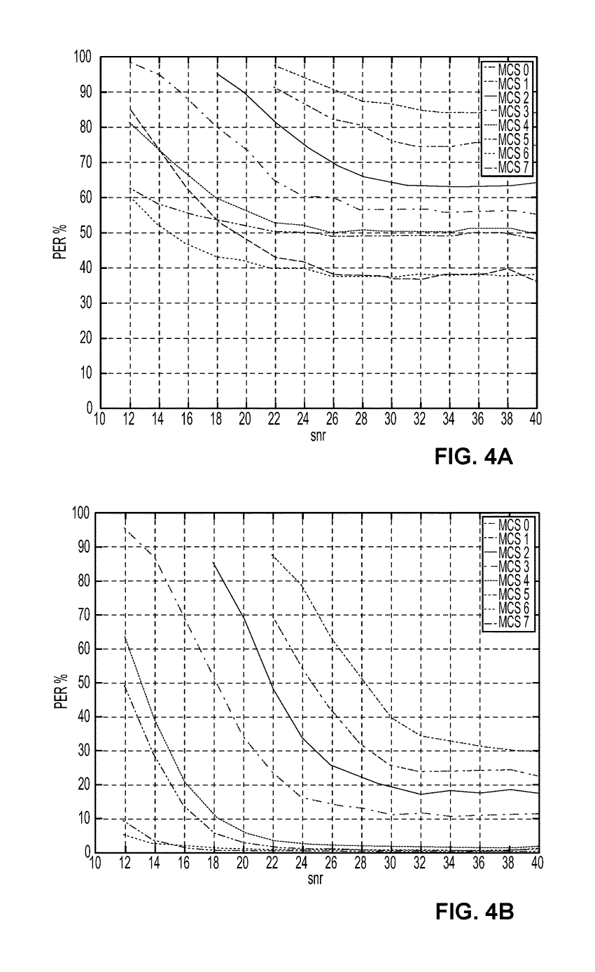

Another effect of the transmitting device traveling at high speed is illustrated FIGS. 4A and 4B. FIG. 4A illustrates a plot of observed packet error rate percentages as a function of signal-to-noise ratio of various MCS values for a frame with only one sub-frame of 1500 bytes (i.e., Sub-frame size=1500 Bytes). As expected, some improvement in packet error rate can be achieved by varying the level of coding used in data packets. However, such improvement may be limited and come at the cost of increased overhead and thus reduced data transmission rates. FIG. 4B illustrates that by reducing the size of the sub-frames, to 300 bytes (i.e., Sub-frame size=300 Bytes), significant improvement in packet error rate may be achieved for the various MCS values. Thus, reducing the size of sub-frames may enable the use of modulation and coding schemes that require less overhead, and thus enable greater data throughput. As a result, a trade-off may be made between the MCS value and the size of sub-frames to permit better data throughput while accommodating effects due to the speed of the transmitting device. Similarly, this implies a similar trade-off may be made between the MCS value and the number of packets or sub-frames within a frame to permit better data throughput.

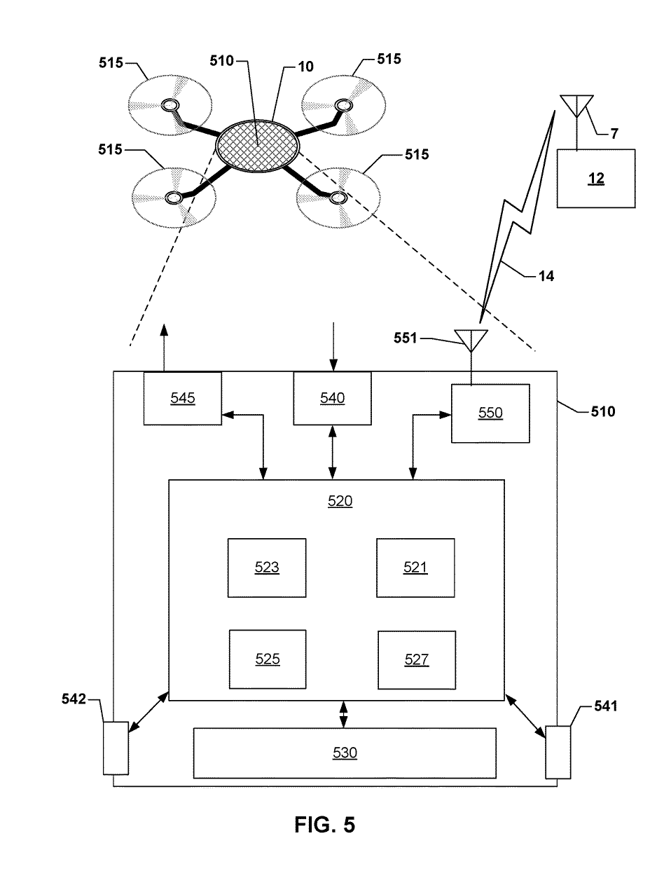

FIG. 5 illustrates a configuration of the UAV 10 that may implement various embodiments. With reference to FIGS. 1-5, the UAV 10 may include a control unit 510 that may house various circuits and devices used to power and control the operation of the UAV 10, as well as any other UAVs controlled by the UAV 10. The control unit 510 may include a processor 520, a power module 530, an input module 540, a camera 541, sensor(s) 542, an output module 545, and a radio module 550 coupled to an antenna 551. The processor 520 may include or be coupled to memory 521 and a navigation unit 523. The processor 520 may be configured with processor-executable instructions to control flight and other operations of the UAV 10, including operations of the various embodiments.

The processor 520 may be coupled to one or more camera 541 and sensor(s) 542. The camera 541 may include one or more image capturing devices. More than one image capturing device may be configured to contemporaneously capture two different images including the target.

The sensor(s) 542 may be optical sensors (e.g., light meters for controlling exposure and determining whether additional illumination is required), radio sensors, a rotary encoder, pressure sensors (i.e., for detecting wind, lift, drag, or changes therein) or other sensors. Alternatively or additionally, the sensor(s) 542 may be contact or pressure sensors that may provide a signal that indicates when the UAV 10 has landed.

The power module 530 may include one or more batteries that may provide power to various components, including the processor 520, the input module 540, the sensor(s) 542, the output module 545, and the radio module 550. In addition, the power module 530 may include energy storage components, such as rechargeable batteries. The processor 520 may be configured with processor-executable instructions to control the charging of the power module 530, such as by executing a charging control algorithm using a charge control circuit. Alternatively or additionally, the power module 530 may be configured to manage its own charging. The processor 520 may be coupled to an output module 545, which may output control signals for managing the motors that drive the rotors 515 and other components.

Through control of the individual motors of the rotors 515, the UAV 10 may be controlled in flight. The processor 520 may receive data from the navigation unit 523 and use such data in order to determine the present position and orientation of the UAV 10, as well as the appropriate course towards the target (e.g., 50). In various embodiments, the navigation unit 523 may include a global navigation satellite system (GNSS) receiver system (e.g., one or more Global Positioning System (GPS) receivers) enabling the UAV 10 to navigate using GNSS signals. Alternatively or in addition, the navigation unit 523 may be equipped with radio navigation receivers for receiving navigation beacons or other signals from radio nodes, such as navigation beacons (e.g., very high frequency (VHF) Omni Directional Radio Range (VOR) beacons), Wi-Fi access points, cellular network sites, radio station, remote computing devices, other UAVs, etc.

The processor 520 and/or the navigation unit 523 may be configured to communicate with a server through a wireless connection (e.g., a cellular data network) to receive commands to use or stop using the extended flight protocol, receive data useful in navigation, provide real-time position altitude reports, and assess data. An avionics module 527 coupled to the processor 520 and/or the navigation unit 523 may be configured to provide flight control-related information such as altitude, attitude, airspeed, heading and similar information that the navigation unit 523 may use for navigation purposes, such as dead reckoning between GNSS position updates. The avionics module 527 may include or receive data from a gyro/accelerometer unit 525 that provides data regarding the orientation and accelerations of the UAV 10 that may be used in navigation and positioning calculations, as well as some of the embodiments.

The radio module 550 may be configured to receive signals via the antenna 551, such as command signals to perform various flight maneuvers, receive signals from aviation navigation facilities, etc., and provide such signals to the processor 520 and/or the navigation unit 523 to assist in operation of the UAV 10. In some embodiments, commands for navigating the UAV 10, or components thereof may be received via the radio module 550. In some embodiments, the UAV 10 may receive signals from the receiving device 12 via uplink signals sent, from an antenna 7, via the wireless signals 14. When sending uplink signals, the roles are reversed and the UAV 10 becomes the receiving device and the controller that was a receiving device 12 becomes the transmitting device.

In some embodiments, the radio module 550 may be configured to switch between a cellular connection and a Wi-Fi or other form of radio connection depending on the location and altitude of the UAV 10. For example, while in flight at an altitude designated for UAV traffic, the radio module 550 may communicate with a cellular infrastructure in order to maintain communications with a server. In addition, communications with the receiving device 12 may be established using cellular telephone networks while the UAV 10 is flying out of line-of-sight with the user 8 and receiving device 12. Communication between the radio module 550 and the operator communication link may transition to a short-range communication link, such as the wireless signals 14 (e.g., Wi-Fi), when the UAV 10 moves closer to the receiving device 12. Similarly, the UAV 10 may include and employ other forms of radio communication, such as mesh connections with other UAVs or connections to other information sources (e.g., balloons or other stations for collecting and/or distributing weather or other data harvesting information).

In various embodiments, the control unit 510 may be equipped with the input module 540, which may be used for a variety of applications. For example, the input module 540 may receive and pre-process images or data from an onboard component, such as camera 541 or sensor(s) 542, or may receive electronic signals from other components (e.g., a payload). The input module 540 may receive an activation signal for causing actuators on the UAV 10 to deploy landing cushions or similar components for affecting an emergency landing. In addition, the output module 545 may be used to activate components (e.g., an energy cell, an actuator, an indicator, a circuit element, a sensor, and/or an energy-harvesting element).

While the various components of the control unit 510 are illustrated in FIG. 5 as separate components, some or all of the components (e.g., the processor 520, the output module 545, the radio module 550, and other units) may be integrated together in a single device or module, such as a system-on-chip (SoC).

For ease of description and illustration, some detailed aspects of the UAV 10 are omitted, such as wiring, frame structure, power source, landing columns/gear, or other features that would be known to one of skill in the art. In addition, although the example UAVs are illustrated as quad copters with four rotors, the UAVs may include more or fewer than four rotors. Also, the UAV 10 may have similar or different configurations, numbers of rotors, and/or other aspects.

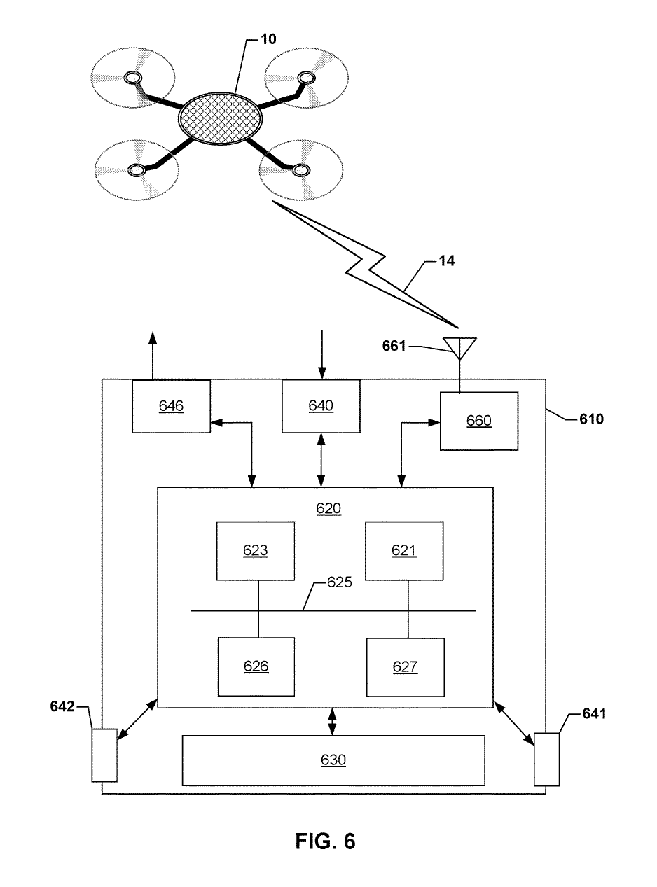

FIG. 6 illustrates components of a receiver device 610 (e.g., a video receiver or UAV controller) suitable for use with the various embodiments. The receiver device 610 may include a computing device 620 coupled to a transceiver 660 configured to send and receive wireless signals 14 via an antenna 661. The computing device 620 may include a processor 621, memory 623, and various other components, such as a graphics processor 626 and a digital signal processor 627, communicatively connected via a bus 625 or other inter-module communication circuits. The receiver device 610 may also include a battery 630 or other power system coupled to the computing device 620. User inputs 641, 642, such as button, knobs, and joysticks may receive inputs from a user, and provide such inputs to the computing device extended 20, such as for sending control commands to a UAV 10. A receiver device 610 may also include various network interfaces 646 for receiving inputs from other computing devices. A receiver device 610 may also include a large storage memory, such as a disc drive 640 or flash memory for storing data (e.g., video frames) received from the UAV 10.

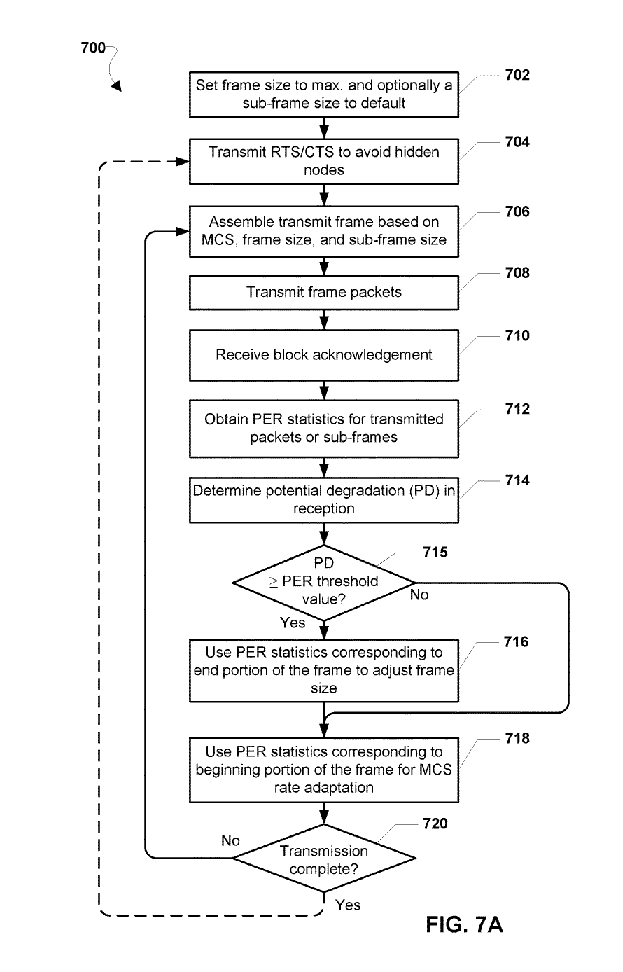

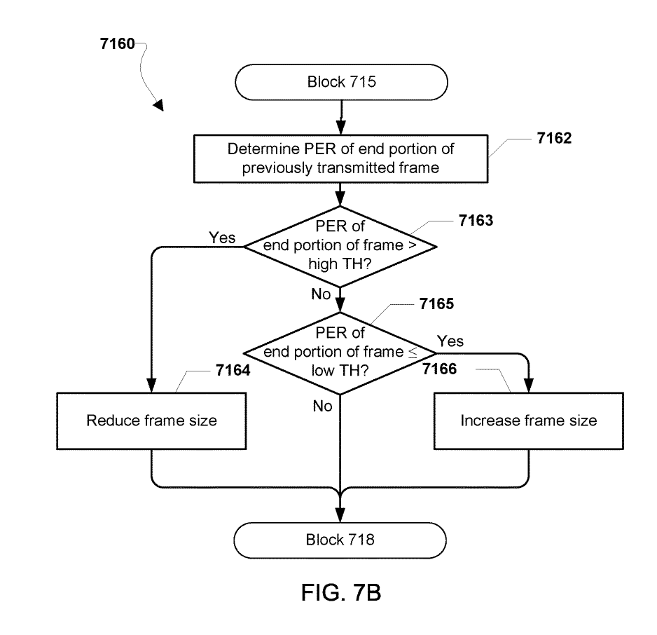

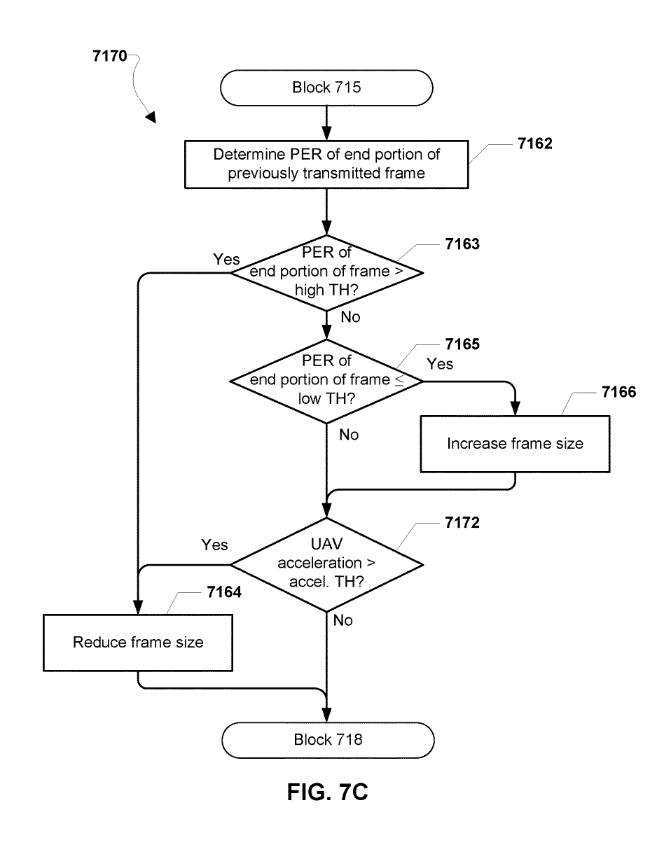

FIG. 7A illustrates a method 700 of managing wireless communications between a transmitting device and a receiving device. The method 700 may adjust a frame size to accommodate Doppler effects from the transmitting device moving with respect to the receiving device according to some embodiments. With reference to FIGS. 1-7A, the operations of the method 700 may be implemented in a processor of the transmitting device (e.g., the processor 520 of the UAV 10) or transmitting radio module, or in a receiving device (e.g., the processor 621 of the receiver device 610) or receiving radio module (e.g., 12) in communication with the transmitting device.

In block 702, the processor of the transmitting device or transmitting radio module may set the frame size to the maximum value and optionally set a sub-frame size to a default value before beginning a transmission burst if no information is available regarding suitable values for size of the frame and/or sub-frames.

In block 704, the processor may transmit the request to transmit send (RTS) and clear to send (CTS) frames to reserve a transmission time and avoid nodes. In 706, the processor may assemble a frame for transmission based upon the set MCS value, frame size, and/or sub-frame size. In block 708, the transmitting radio module may transmit the assembled frame and associated packets.

In block 710, the processor may receive the block acknowledgment, and the processor may obtain the packet error rate (PER) statistics for the transmitted packets or sub-frames in block 712. The obtained PER statistics in block 712 may include PER of one or more previously transmitted frames.

In block 714, the processor may determine a potential degradation (PD) in reception of information within a frame to be transmitted due to relative motions of the transmitting device and the receiving device. To determine the potential degradation, the processor may evaluate the obtained PER statistics from block 712, which may include an analysis of only an end portion (e.g., a second half) of a frame. The processor may determine the potential degradation using a Doppler velocity between the transmitting device and the receiving device calculated based upon a position of the receiving device that is stationary, a position of the transmitting device, and a velocity vector of the transmitting device. Alternatively, the processor may determine the potential degradation using a Doppler velocity between the transmitting device and the receiving device calculated based upon a position of the transmitting device that is stationary, a position of the receiving device, and a velocity vector of the receiving device. As a further alternative when both the transmitting device and the receiving device are moving independently of one another, the processor may determine the potential degradation using a Doppler velocity between the transmitting device and the receiving device calculated based upon a position and velocity vector of the transmitting device and a position and velocity vector of the receiving device.

In determination block 715, the processor may determine whether the potential degradation, determined in block 714, will exceed (or equal) a packet error rate (PER) threshold value (i.e., PD≧PER threshold). The PER threshold value may be a certain rate or percentage (e.g., 50% or other value).

In response to determining that the potential degradation will exceed (or equal) the PER threshold value (i.e., determination block 715=“Yes”), the processor may use the obtained PER statistics from the end portion of the frame for frame size adjustment in block 716. In response to determining that the potential degradation will not exceed (or equal) the PER threshold value (i.e., determination block 715=“No”), the processor may use obtained PER statistics for MCS rate adaptation in block 718.

In block 716, the processor may use the PER statistics corresponding to the end portion of the frame to adjust the frame size for the next frame to be transmitted. For example, the processor may use the PER statistics corresponding to a second half of the frame (i.e., the end portion of the frame) to adjust the frame size. As discussed (e.g., with reference to FIG. 3B), the sub-frames towards the end of the frame may have potential degradation in the reception of information within the frame due to relative motions of the transmitting device and the receiving device. Therefore, the processor may look to the sub-frames affected by a relative speed of the transmitting device (e.g., the Doppler velocity) and determine whether an adjustment should be made to accommodate the relative speed of the transmitting device. The processor may adjust a size of the next frame to be transmitted by increasing or reducing the size of the next frame to be transmitted. The adjustment of the size of the next frame to be transmitted may include changing the number of included packets or sub-frames, the time between the synchronization, and/or channel estimate symbols in the preamble to the last sub-frame. For example in Wi-Fi transmissions, the frame to be transmitted is an AMPDU including a number of MPDUs, so that adjusting the size of the frame to be transmitted may include changing (e.g., reducing or increasing) at least one of a number or a size of MPDUs in the AMPDU.

In some embodiments, a target size of the next frame for adjustment may be determined in block 716 based on the average PER in the end portion of the preceding frame by using a table look up method, using the packet error rate to retrieve a frame size corresponding to the packet error rate (or range within which the packet error rate falls).

In block 718, the processor may use the obtained PER statistics corresponding to the beginning portion of the frame for MCS rate adaptation. For example, the processor may use only the PER statistics corresponding to a beginning portion (i.e., first few packets or sub-frames) of a frame for MCS rate adaptation.

In determination block 720, the processor may determine whether the burst transmission is complete. If not (i.e., determination block 720=“No”), the processor may assemble and transmit the next frame via the transmitting radio module in blocks 706 and 708 and repeat the operations in blocks 710-720. If the burst transmission is complete (i.e., determination block 720=“Yes”), the processor may wait until the next burst transmission time, before repeating the operations in blocks 704-720.

FIG. 7B illustrates a method 7160 of adjusting the frame size of a wireless communication link, which is an example of operations that may be performed in block 716 of the method 700 of managing wireless communications between a transmitting device and a receiving device. With reference to FIGS. 1-7B, in block 7162, the processor may determine an average PER in an end portion of a previously transmitted frame.

In determination block 7163, the processor may determine whether the average PER in the end portion of the previously transmitted frame is greater than a first (high) threshold (i.e., PER of end portion of frame>high TH). For example, the processor may determine an average of the PER in the second (i.e., later) half of the frame.

In response to determining that the average PER in the end portion of the previously transmitted frame is greater than the first (high) threshold (i.e., determination block 7163=“Yes”), the processor may reduce the frame size for the next transmission in block 7164. For example, the processor may reduce the size of the next frame by 50 percent (i.e., halving the number of included packets or sub-frames).

In response to determining that the average PER in the end portion of the previously transmitted frame is not greater than the first (high) threshold (i.e., determination block 7163=“No”), the processor may determine whether the average PER in the end portion of the previously transmitted frame equals or is less than a second (low) threshold (i.e., PER of end portion of frame≦low TH) in determination block 7165. The second (low) threshold is lower than the first (high) threshold.

In response to determining that the average PER in the end portion of the previously transmitted frame equals or is less than a second (low) threshold (i.e., determination block 7165=“Yes”), the processor may increase the frame size for the next transmission in block 7166. For example, the processor may increase the size of the next frame by 25 percent (i.e., increasing the number of included packets or sub-frames by a quarter) or other value.

In response to determining that the average PER in the end portion of the previously transmitted frame is greater than the second (low) threshold (i.e., determination block 7165=“No”), and after either reducing the size of the next frame in block 7164 or increasing the size of the next frame in block 7166, the processor may proceed with the operations in block 718 of the method 700.

FIG. 7C illustrates a method 7170 of adjusting the frame size of a wireless communication link, which is an example of the operations that may be performed in block 716 of the method 700 of managing wireless communications between a transmitting device and a receiving device. In the method 7170, the operations of blocks 7162, 7164, and 7166, as well as determination blocks 7163 and 7165, may be performed as described for like numbered blocks of the method 7160. With reference to FIGS. 1-7C, in addition to determining an average PER in the end portion of the previously transmitted frame (i.e., block 7162), whether the average PER is greater than a first (high) threshold (i.e., determination block 7163), and/or whether the average PER equals or is less than greater than a second (low) threshold (i.e., determination block 7165), the processor may consider information regarding the relative motion of the transmitting device based on sensors or known actions of the device when adjusting the frame size. This may enable the processor to determine the potential for degradation of (i.e., anticipate impacts to) the channel conditions caused by sudden movements occurring just before the frame is assembled. For example, as part of the operations in block 716, the processor (e.g., of the UAV 10) may determine whether accelerometers are detecting accelerations that meet an acceleration threshold in determination block 7172.

In response to detecting accelerations exceeding the acceleration threshold (i.e., determination block 7172=“Yes”), the processor may reduce the size of the next frame in block 7164, regardless of whether the PER of the end portion of the previous frame was not greater than the high threshold (i.e., even if determination block 7163=“No”). In response to not detecting accelerations exceeding the acceleration threshold or detecting accelerations that do not exceed the acceleration threshold (i.e., determination block 7172=“No”), and after adjusting the size of the next frame in block 7164, the processor may proceed with the operations in block 718 of the method 700.

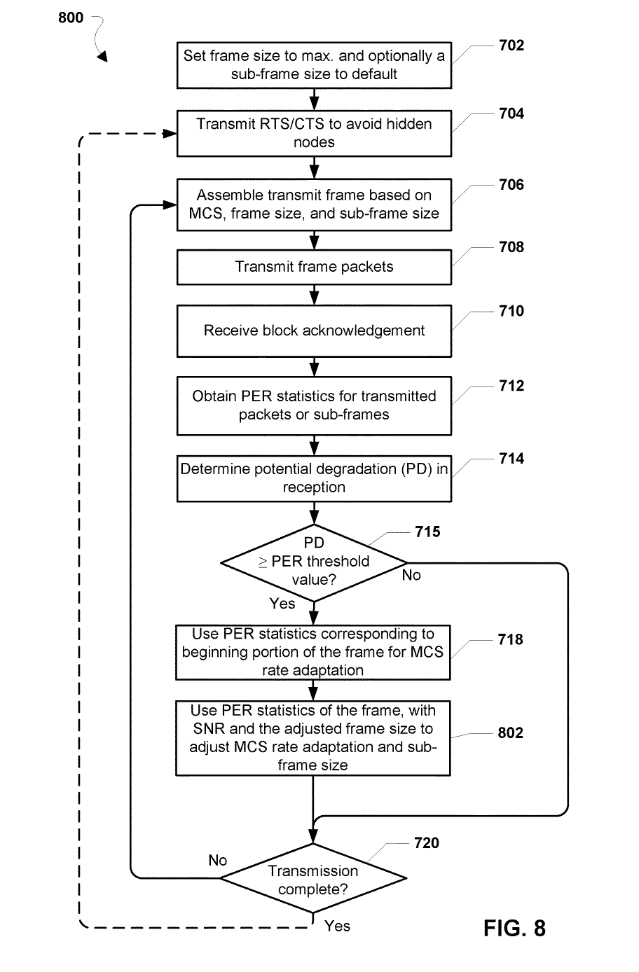

As described, the size of packets or sub-frames may be reduced in order to enable the use of MCS values with less overhead, and sub-frame size and MCS value may be traded off against one another to achieve a favorable data throughput. FIG. 8 illustrates a method 800 of managing wireless communications between a transmitting device and a receiving device. The method 800 may adjust the frame size, sub-frame size, and MCS value to accommodate Doppler effects from the transmitting device moving with respect to the receiving device according to some embodiments. With reference to FIGS. 1-8, the operations of the method 800 may be implemented in a processor of the transmitting device (e.g., the processor 520 of the UAV 10) or the transmitting radio module, or in a receiving device (e.g., the processor 621 of the receiver device 610) or a receiving radio module in communication with the transmitting radio module. In the method 800, the operations of blocks 702-715, 718, and 720 may be performed as described for like numbered blocks of the method 700.

In block 802, the processor may filter the obtained PER statistics to use only those PER statistics that correspond to the beginning portion of the frame, in combination with the signal-to-noise ratio (i.e., SNR) and the adjusted frame size, to adjust the MCS rate adaptation and the sub-frame size to achieve a balance between transmission reliability and data throughput. The sub-frame size may be controlled by setting the Maximum Transmission Unit (MTU) to the upper layer to avoid frame fragmentations.

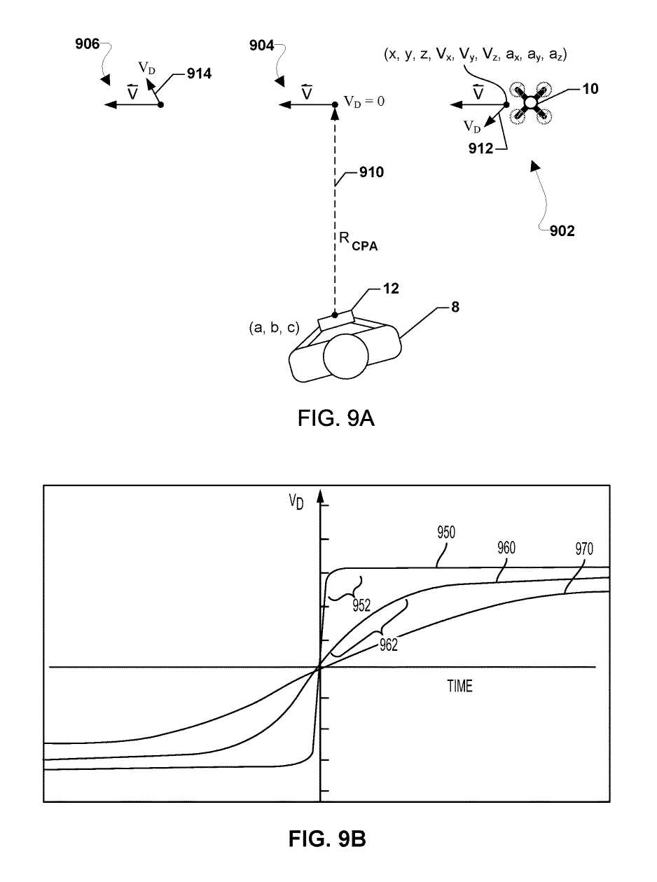

In a further embodiment, the processor (or processor of a receiving device in communication with the transmitting device) may estimate the Doppler velocity (i.e., the relative velocity between the transmitting device and the receiving device) based upon information known to the transmitting device and the receiving device in terms of location, speed, and direction of travel, and rates of acceleration. As illustrated in FIG. 9A, a transmitting device, in the form of the UAV 10, may maintain or determine information corresponding to a position, velocity vector, and rates of acceleration of the transmitting device. The UAV 10 may maintain such information in a navigation and avionics system (e.g., navigation unit 523). Using geometry, a processor of the UAV may use coordinates of the UAV's position (x, y, z), velocity (Vₓ, V_{y}, V_{z}), and acceleration (aₓ, a_{y}, a_{z}), as well as coordinates (a, b, c) of the receiving device 12 to calculate the Doppler velocity (V_{D}) 912 along a line of sight (LOS) direction between the receiving device 12 and the UAV 10 at a given position (e.g., position 902).

Further, using the nine UAV coordinates (i.e., x, y, x, Vₓ, V_{y}, V_{z}, aₓ, a_{y}, a_{z}) and the controller coordinates (i.e., a, b, c), the processor may be able to estimate the dynamic changes in Doppler velocity V_{D} that will be observed by the receiving device 12, by calculating a closest point of approach (CPA) position 904, where the Doppler velocity V_{D} may equal zero. The rate of change of the Doppler velocity V_{D} may be estimated as a function of time based on the current velocity V (increased by any acceleration) and the CPA distance R_{CPA} 910 between the receiving device 12 and the UAV 10. Similarly, the processor may be able to estimate the dynamic changes in Doppler velocity V_{D} 914 that will be observed by the receiving device 12 at another position 906.

As illustrated in FIG. 9B, the rate of change in the Doppler velocity observed by the receiving device (e.g., 12) for a transmitting device (e.g., UAV 10) traveling at a given speed will depend upon the distance between transmitting device and receiving device at the CPA. A first plot 950 of Doppler velocity changes reflects a circumstance in which the transmitting device will pass very close to the receiving device such that the CPA is a relatively small distance. The first plot demonstrates how the receiving device will observe very little change in the Doppler velocity (i.e., the Doppler frequency shift will remain virtually constant) until just before and just after the transmitting device passes. However, a relatively large maximum rate of change 952 will occur just before and just after the transmitting device passes. A second plot 960 of Doppler velocity changes reflects a circumstance in which the transmitting device will pass at a moderate distance from the receiving device such that the CPA is an intermediate distance away (the distance depending upon the speed of the transmitting device). The second plot 960 demonstrates that the receiving device will observe an exponential change in the Doppler velocity well before and well after the transmitting device passes, with a moderate maximum rate of change 962 further from the CPA than the first plot 950. A third plot 970 of Doppler velocity changes reflects a circumstance in which the transmitting device will pass at a large distance to the receiving device (i.e., a large CPA). The third plot 970 demonstrates that the receiving device will observe a gradual, almost linear, rate of change in the Doppler velocity (i.e., the Doppler frequency shift will change slowly) long before and long after the transmitting device passes the receiving device, with a low maximum rate of change further from the CPA than the second plot 960. Thus, using geometry, the known positions of transmitting and receiving devices, and the relative speed of the transmitting device, the rates of change in the Doppler velocity can be predicted in advance. Thus, the frame/AMDPU size may be adjusting using the predicted rates of change in Doppler velocity in anticipation of the affects.

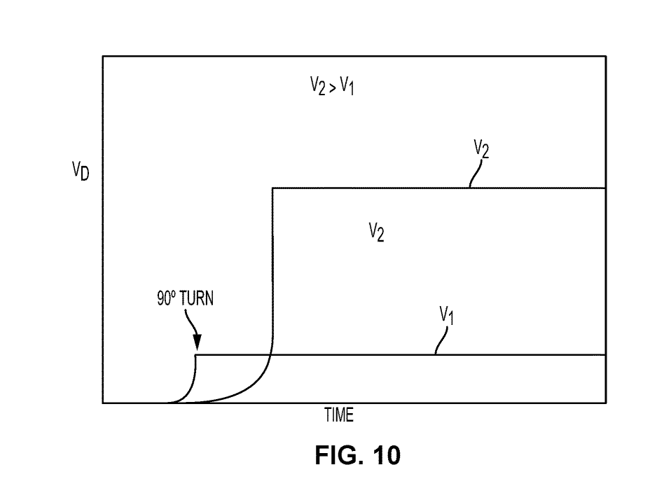

In addition to causing a predictable change in Doppler velocity due to geometry as described with reference to FIGS. 9A and 9B, transmitting devices that are traveling at high speed will exhibit increasing Doppler shifts due to sudden maneuvers as speed increases. This is illustrated in FIG. 10, which shows notionally the change in Doppler velocity (V_{D}) observed when transmitting devices make a 90 degree turn at two speeds, V1 and V2. If prior to the turn the transmitting device was traveling at a constant distance from the receiving device (e.g., traveling in a circle), the Doppler velocity would be zero as illustrated. When the transmitting device turns toward or away from the receiving device in a 90-degree turn, the Doppler velocity will promptly rise (or fall below zero) to equal the speed of the transmitting device. Thus, the transmitting device traveling at the higher velocity V2 will exhibit a much larger change in Doppler velocity.

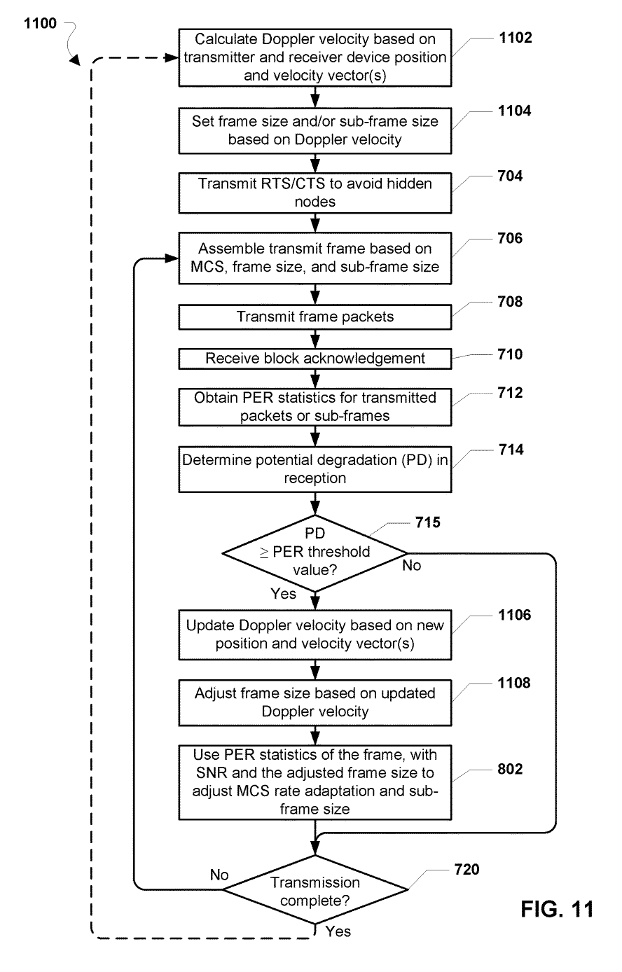

FIG. 11 illustrates a method 1100 of managing wireless communications between a transmitting device and a receiving device. The method 1100 may adjust the frame size, sub-frame size, and MCS value to accommodate Doppler effects from the transmitting device moving with respect to the receiving device by calculating the Doppler velocity based on known positions of the transmitting and receiving devices and the velocity of the transmitting device according to some embodiments. With reference to FIGS. 1-11, the operations of the method 1100 may be implemented in a processor of the transmitting device (e.g., processor 520 of a UAV 10) or the transmitting radio module or in a receiving device (e.g., processor 621 of the receiver device 610) or a receiving radio module in communication with the transmitting device. In the method 1100, the operations of blocks 704-715 and 720 may be performed as described for like numbered blocks of the method 700. Similarly, in the method 1100, the operations of block 802 may be performed as described for block 802 of the method 800.

In block 1102, the processor of the transmitting device may use the known positions and velocity vector(s), if applicable, of the transmitting device (e.g., UAV 10) and the receiving device (e.g., 12) to calculate the Doppler velocity.

In block 1104, the processor may set the frame size and/or sub-frame size based on the Doppler velocity. The processor may obtain an appropriate size for both the frame size and/or the sub-frame size by using a table look up method using the calculated Doppler velocity from block 1102 to identify the appropriate values in a data table stored in the memory (e.g., 521, 623).

In block 1106, the processor may update the Doppler velocity calculation based on new position and/or velocity vector information for the transmitting and/or receiving devices before transmitting the next frame, and adjust the frame size based on the updated Doppler velocity in block 1108.

In some embodiments, the processor may calculate a distance between the transmitting device and the receiving device based upon a known transmitting position of the transmitting device and a known or determined position of the receiving device. The calculated distance may be used by the processor to estimate a signal to noise ratio (SNR) base for the next frame, and that estimate may be used to select an MCS value to use in the frame to be transmitted. That MCS value may then be modified based on adjustments to the frame.

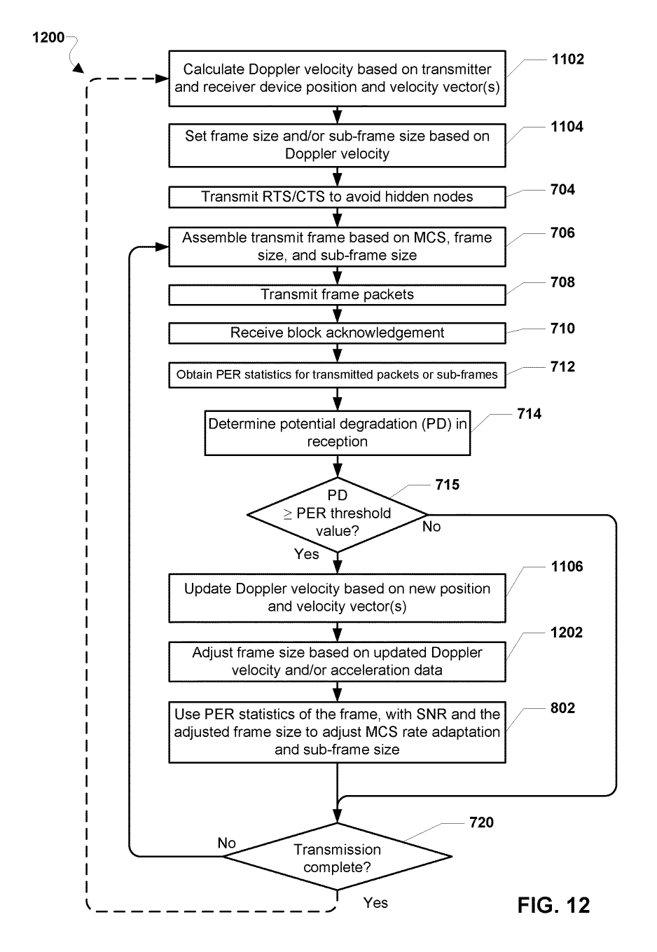

FIG. 12 illustrates a method 1200 of managing wireless communications between a transmitting device and a receiving device. The method 1200 may adjust the frame size, sub-frame size, and MCS value to accommodate Doppler effects from the transmitting device moving with respect to the receiving device by calculating the Doppler velocity based on known positions of the transmitting and receiving devices and the velocity of the transmitting device and the receiving device, and adjusting the calculations based on measurements of acceleration according to some embodiments. With reference to FIGS. 1-12, the operations of the method 1200 may be implemented in a processor of the transmitting device (e.g., processor 520 of a UAV 10) or a transmitting radio module or in a receiving device (e.g., processor 621 of the receiver device 610) or receiving radio module in communication with the transmitting device. In the method 1200, the operations of blocks 704-715 and 720 may be performed as described for like numbered blocks of the method 700, block 802 may be performed as described for block 802 of the method 800, and blocks 1102 and 1104 may be performed as described for like numbered blocks of the method 1100.

In block 1202, the processor of the transmitting device may obtain accelerometer data from accelerometers on the transmitting device (e.g., accelerometers used in the avionics system), and use the accelerometer data to adjust the frame size based on both the updated Doppler velocity and/or accelerometer data. In this manner the processor may be able to anticipate changes in the Doppler velocity that will be observed by the receiving device due to the accelerations occurring just as the frame is about to be transmitted. In some embodiments, the acceleration data may be compared to a threshold, and adjustments to the frame size may consider the accelerometer data if the acceleration data exceeds the threshold.

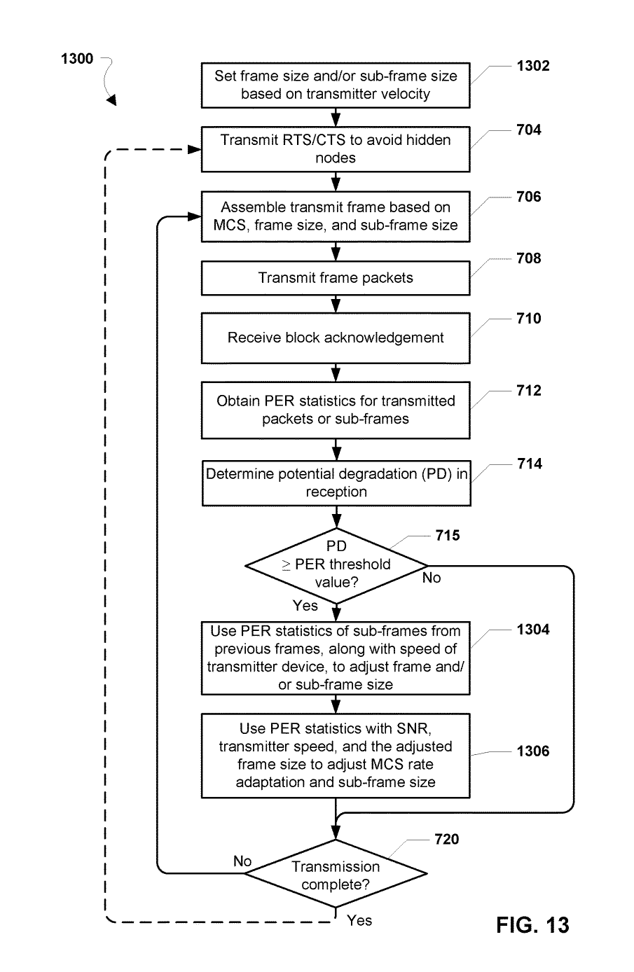

FIG. 13 illustrates a method 1300 of managing wireless communications between a transmitting device and a receiving device. The method 1300 may adjust the frame size, sub-frame size, and MCS value to accommodate Doppler effects from the transmitting device moving with respect to the receiving device based just on the speed of the transmitting device according to some embodiments. With reference to FIGS. 1-13, the operations of the method 1300 may be implemented in a processor of the transmitting device (e.g., processor 520 of a UAV 10) or a transmitting radio module or in a receiving device (e.g., processor 621 of the receiver device 610) or receiving radio module in communication with the transmitting device. In the method 1300, the operations of blocks 704-715 and 720 may be performed as described for like numbered blocks of the method 700.

In block 1302, the processor may use a relative velocity (i.e., speed and/or direction of travel) of the transmitting device (e.g., the airspeed of a UAV relative to position/movement of the receiving device) to set the frame size and/or sub-frame size in block 1302. For example, the processor may determine whether the current relative speed of the transmitting device exceeds a velocity threshold value. The velocity threshold value may be set based on a velocity at which Doppler effects are known or have been observed to impact communications by causing degradation of packets within a frame. Based on the determined current relative speed, the processor may use a look up table stored in a memory (e.g., 521) to identify a suitable size for the frame and/or sub-frame. In other words, the size of the frame and/or sub-frame may be set at a value determined by using the relative speed of the transmitting device to perform a look up in a table of transmission frames sizes correlated to speed. An example table of correlating transmission frames sizes to speed is illustrated in Table 1, below. Thus, without knowledge of the location of the receiving device, before receiving packet error rate feedback from previous transmission bursts, the transmitting radio module may adjust the frame size and sub-frame size in a manner that is conservative enough to enable the first frame to be received.

TABLE 1

| Speed | | AMPDU size |
|---|---|---|
| 0-5 | m/s | 10 |
| >5 | m/s | 3 |

In block 1304, the processor may use the PER statistics of the sub-frames of the previous frame, in combination with the relative speed of the transmitting device (e.g., airspeed of a UAV relative to position/movement of the receiving device), to adjust the frame and/or sub-frame size. Again, the processor may use the relative speed of the transmitting device as a look up factor in a data table in memory to identify a suitable size for the frame and/or sub-frame. The data table may correlate frame and/or sub-frame sizes to relative speeds or speed ranges. Thus, the relative speed of the transmitting device may be used to reduce and/or eliminate packet error rates before the next frame is transmitted.

In block 1306, the processor may use the obtained PER statistics, in combination with the signal-to-noise ratio (i.e., SNR), the speed of the transmitting device (e.g., airspeed of a UAV), and the adjusted frame size, to adjust the MCS rate adaptation and the sub-frame size to achieve a balance between transmission reliability and data throughput.

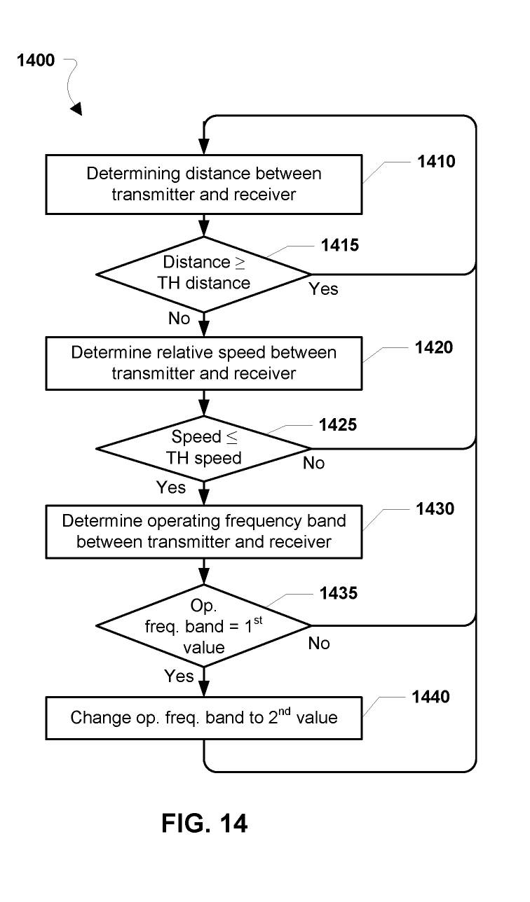

FIG. 14 illustrates a method 1400 of managing wireless communications between a transmitting device and a receiving device. The method 1400 may change an operating frequency band of the wireless communications between the transmitting device and the receiving device under certain predetermined circumstances. With reference to FIGS. 1-14, the operations of the method 1400 may be implemented in a processor of the transmitting device (e.g., processor 520 of a UAV 10) or the transmitting radio module, or in a receiving device (e.g., processor 621 of the receiver device 610) or a receiving radio module in communication with the transmitting device.

In block 1410, the processor may determine a current distance between the transmitting device and the receiving device. This determination may be made using a variety of techniques, including for example, calculating the distance between the GPS locations of the transmitting device and receiving device when both locations are known, using time-of-flight information based on communications exchanged between the transmitting and receiving devices, using signal strength of signals as measured by the receiving device, etc.

In determination block 1415, the processor may determine whether the current distance determined in block 1410 equals or exceeds a threshold distance (i.e., Distance≧TH Distance). The threshold distance may be set to a distance at which Doppler effects are known or have been observed to have little impact on communications because any degradation of packets within a frame due to Doppler effects are manageable within the communication error correction methods. For example, the threshold distance may be 500 meters.

In response to determining that the determined current distance equals or exceeds the threshold distance (i.e., determination block 1415=“Yes”), the processor may periodically redetermine the distance between the transmitting device and receiving device in block 1410.

In response to determining that the determined current distance is less than the threshold distance (i.e., determination block 1415=“No”), the processor may determine the relative speed between the transmitting device and the receiving device in block 1420, and determine whether the relative speed determined in block 1420 equals or is less than a threshold speed (i.e., Speed≦TH Speed) in determination block 1425. The threshold speed may be set at a speed at which Doppler effects are known or have been observed to impact communications by causing degradation of packets within a frame. For example, the threshold speed may be 25 kilometers per hour.

In response to determining that the relative speed between the transmitting device and the receiving device is greater than the threshold speed (i.e., determination block 1425=“No”), the processor may periodically redetermine the distance between the transmitting and receiving devices in block 1410.

In response to determining that the relative speed between the transmitting device and the receiving device is equal to or less than the threshold speed (i.e., determination block 1425=“Yes”), the processor may determine the operating frequency band (i.e., Op. Freq. Band) of the wireless communications between the transmitting device and the receiving device in block 1430.

In determination block 1435, the processor may determine whether the current operating frequency band determined in block 1430 is set to a first predetermined value (e.g., 2.4 GHz). The first predetermined value may be set based on an operating frequency band at which Doppler effects are known or have been observed to impact communications by causing degradation of packets within a frame.

In response to determining that the current operating frequency band is set to the first predetermined value (i.e., determination block 1435=“Yes”), the processor may change the operating frequency band to a second predetermined value (e.g., 5 GHz) at which Doppler effects are known or have been observed to a tolerable impact on communications in block 1440. In response to the processor determining that the current operating frequency band is not set to the first predetermined value (i.e., determination block 1435=“No”), the processor may periodically redetermine the distance between the transmitting and receiving devices in block 1410.

In various embodiments, the order of the operations of the method 1400 may be changed, although the determinations in the determination blocks 1415, 1425, 1435 should occur subsequent to the respective immediately preceding determination blocks 1410, 1420, 1430. For example, determining the relative speed between the transmitting and receiving devices in block 1420 may be performed before determining the distance between the transmitting and receiving devices in block 1410. Similarly, determining the operating frequency band in block 1430 may be performed before determining the relative speed between the transmitting and receiving devices in block 1420.

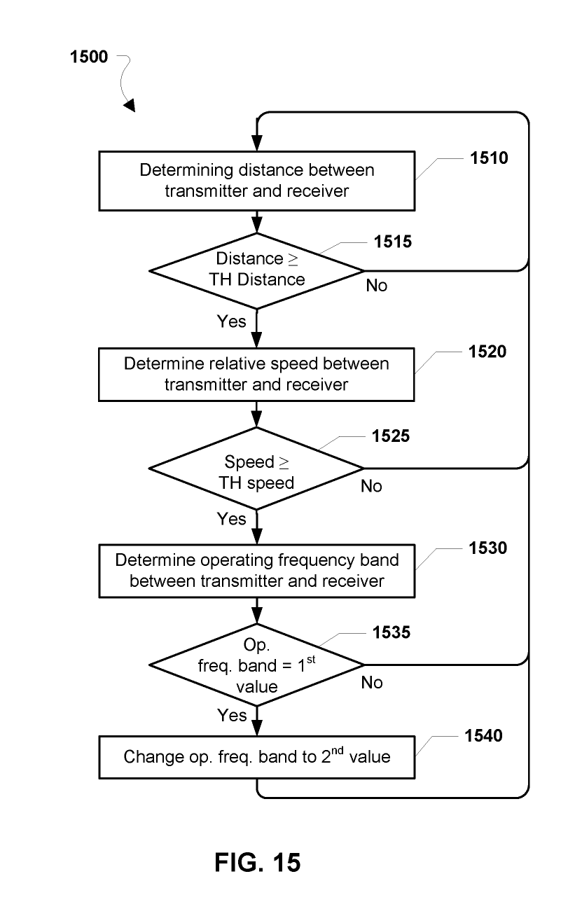

FIG. 15 illustrates a method 1500 of managing wireless communications between a transmitting device and a receiving device. The method 1500 may change an operating frequency band of the wireless communications between the transmitting device and the receiving device under certain predetermined circumstances. With reference to FIGS. 1-15, the operations of the method 1500 may be implemented in a processor of the transmitting device (e.g., processor 520 of a UAV 10) or a transmitting radio module, or in a receiving device (e.g., processor 621 of the receiver device 610) or a receiving radio module in communication with the transmitting device.

In block 1510, the processor may determine a current distance between the transmitting device and receiving device. This determination may be made using a variety of techniques, including for example, calculating the distance between the GPS locations of the transmitting device and receiving device when both locations are known, using time-of-flight information based on communications exchanged between the transmitting and receiving devices, using signal strength of signals as measured by the receiving device, etc.

In determination block 1515, the processor may determine whether the current distance determined in block 1510 equals or exceeds a threshold distance (i.e., Distance≧TH Distance). The threshold distance may be set to a distance at which Doppler effects are known or have been observed to have little impact on communications because any degradation of packets within a frame due to Doppler effects are manageable within the communication error correction methods. For example, the threshold distance may be 500 meters.

In response to determining that the determined current distance equals or exceeds the threshold distance (i.e., determination block 1515=“Yes”), the processor may determine the relative speed between the transmitting device and the receiving device in block 1520.

In response to determining that the determined current distance is less than the threshold distance (i.e., determination block 1515=“No”), the processor may periodically redetermine the distance between the transmitting and receiving devices in block 1510.

In determination block 1525, the processor may determine whether the relative speed determined in block 1520 is greater than or equal to a threshold speed (i.e., Speed≧TH Speed) in determination block 1525. The threshold speed may be set at a speed at which Doppler effects are known or have been observed to impact communications by causing degradation of packets within a frame. For example, the threshold speed may be 25 kilometers per hour.

In response to determining that the relative speed between the transmitting device and the receiving device is greater than or equal to the threshold speed (i.e., determination block 1525=“Yes”), the processor may determine the operating frequency band of the wireless communications between the transmitting device and the receiving device in block 1530.

In response to determining that the relative speed between the transmitting device and the receiving device is less than the threshold speed (i.e., determination block 1525=“No”), the processor may periodically redetermine the distance between the transmitting and receiving devices in block 1510.

In determination block 1535, the processor may determine whether the current operating frequency band (i.e., Op. Freq. Band) determined in block 1530 is set to a first predetermined value (e.g., 5 GHz). The first predetermined value may be set based on an operating frequency band at which Doppler effects are known or have been observed to impact communications by causing degradation of packets within a frame.

In response to determining that the current operating frequency band (i.e., Op. Freq. Band) is set to the first predetermined value (i.e., determination block 1535=“Yes”), the processor may change the operating frequency band to a second predetermined value (e.g., 2.4 GHz) at which Doppler effects are known or have been observed to a tolerable impact on communications in block 1540.

In response to determining that the current operating frequency band is not set to the first predetermined value (i.e., determination block 1535=“No”), the processor may periodically redetermine the distance between the transmitting and receiving devices in block 1510.

In various embodiments, the order of the operations of the method 1500 may be changed, although the determinations in the determination blocks 1515, 1525, 1535 should occur subsequent to the respective immediately preceding determination blocks 1510, 1520, 1530. For example, determining the relative speed between the transmitting and receiving devices in block 1520 may be performed before determining the distance between the transmitting and receiving devices in block 1510. Similarly, determining the operating frequency band in block 1530 may be performed before determining the relative speed between the transmitting and receiving devices in block 1520.

While the various embodiments are described for a moving transmitting device transmitting to a stationary receiving device, such as will often be the case for a UAV (e.g., 10) communicating with a ground-based controller (e.g., receiving device 12), the various embodiments apply equally well to situations in which the transmitting device is stationary and the receiving device is moving, as well as situations in which both the transmitting and receiving devices are moving independently.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of managing wireless communications between a transmitting device and a receiving device, comprising:
determining whether a potential degradation in reception of information within a frame to be transmitted due to relative motion of the transmitting device and the receiving device will equal or exceed a first packet error rate threshold value; and
adjusting a size of the frame to be transmitted in response to determining that the potential degradation in the reception of information within the frame to be transmitted will equal or exceed the first packet error rate threshold value.

2. The method of claim 1, wherein adjusting the size of the frame to be transmitted comprises reducing a number of sub-frames included within the frame.

3. The method of claim 1, wherein adjusting the size of the frame to be transmitted comprises reducing a size of sub-frames included within the frame.

4. The method of claim 1, wherein adjusting the size of the frame to be transmitted comprises setting the size of the frame to be transmitted using information obtained from a data table in memory.

5. The method of claim 1, further comprising:
determining whether packet error rates of an end portion of a previously transmitted frame are greater than a second packet error rate threshold value,
wherein adjusting the size of the frame to be transmitted includes reducing the size of the frame to be transmitted in response to determining that the packet error rates of the end portion of the previously transmitted frame are greater than the second packet error rate threshold value.

6. The method of claim 1, further comprising:
determining whether packet error rates of sub-frames within an end portion of a previously transmitted frame are less than or equal to a third packet error rate threshold value, wherein adjusting the size of the frame to be transmitted includes increasing the size of the frame to be transmitted in response to determining that the packet error rates of the end portion of the previously transmitted frame are less than or equal to the third packet error rate threshold value.

7. The method of claim 1,
wherein the wireless communications are Wi-Fi transmissions;
wherein the frame to be transmitted is an aggregated media access control packet data unit (AMPDU) including a number of media access control packet data units (MPDUs); and
wherein adjusting the size of the frame to be transmitted comprises reducing or increasing at least one of a number or a size of MPDUs in the AMPDU.

8. The method of claim 7, further comprising:
determining whether packet error rates of MPDUs within an end portion of a previously transmitted AMPDU are greater than a second packet error rate threshold value,
wherein adjusting the size of the frame to be transmitted includes reducing the size of the frame to be transmitted in response to determining that the packet error rates of MPDUs within the end portion of the previously transmitted AMPDU are greater than the second packet error rate threshold value.

9. The method of claim 7, further comprising:
determining whether packet error rates of MPDUs within an end portion of a previously transmitted AMPDU are less than or equal to a third packet error rate threshold value, wherein adjusting the size of the frame to be transmitted includes increasing at least one of the number or the size of the MPDUs in the AMPDU to be transmitted in response to determining that the packet error rates of MPDUs within the end portion of the previously transmitted AMPDU equal or do not exceed a third packet error rate threshold value.

10. The method of claim 1, wherein determining whether the potential degradation in the reception of information within the frame to be transmitted due to the relative motion of the transmitting device and the receiving device will equal or exceed the first packet error rate threshold value comprises:
calculating a Doppler velocity between the transmitting device and the receiving device based upon a position of the receiving device that is stationary, a device position of the transmitting device, and a velocity vector of the transmitting device.

11. The method of claim 1, wherein determining whether the potential degradation in the reception of information within the frame to be transmitted due to the relative motion of the transmitting device and the receiving device will equal or exceed the first packet error rate threshold value comprises:
calculating a Doppler velocity between the transmitting device and the receiving device based upon a position of the transmitting device that is stationary, a position of the receiving device, and a velocity vector of the receiving device.

12. The method of claim 1, wherein determining whether the potential degradation in the reception of information within the frame to be transmitted due to the relative motion of the transmitting device and the receiving device will equal or exceed the first packet error rate threshold value comprises:
calculating a Doppler velocity between the transmitting device and the receiving device based upon a position of the transmitting device and a velocity vector of the transmitting device and a position of the receiving device and a velocity vector of the receiving device, wherein both the transmitting device and the receiving device are moving independently of one another.

13. The method of claim 1, further comprising:
calculating a distance between the transmitting device and the receiving device based upon a position of the transmitting device and a position of the receiving device;
estimating a signal to noise ratio based on the calculated distance; and
using the estimated signal to noise ratio to select a modulation and coding scheme value to use in the frame to be transmitted.

14. The method of claim 1, further comprising:
calculating a distance between the transmitting device and the receiving device;
determining a relative speed between the transmitting device and the receiving device;
determining whether an operating frequency band of the wireless communications between the transmitting device and the receiving device is set to a first predetermined value; and
changing the operating frequency band to a second predetermined value in response to the calculated distance between the transmitting device and the receiving device being less than a threshold distance, the determined relative speed being less than or equal to a threshold speed, and determining that the operating frequency band is set to the first predetermined value.

15. The method of claim 1, further comprising:
calculating a distance between the transmitting device and the receiving device;
determining a relative speed between the transmitting device and the receiving device;
determining whether an operating frequency band of the wireless communications between the transmitting device and the receiving device is set to a first predetermined value; and
changing the operating frequency band to a second predetermined value in response to the calculated distance between the transmitting device and the receiving device being greater than a threshold distance and determining that the operating frequency band is set to the first predetermined value.

16. The method of claim 1, wherein determining whether the potential degradation in the reception of information within the frame to be transmitted due to the relative motion of the transmitting device and the receiving device will equal or exceed the first packet error rate threshold value comprises:
comparing a relative speed between the transmitting device and the receiving device to a speed threshold value; and
determining that the potential degradation in the reception of information within the frame to be transmitted will equal or exceed the first packet error rate threshold value in response to the relative speed between the transmitting device and the receiving device exceeding the speed threshold value.

17. The method of claim 16, wherein the speed threshold value depends on an operating frequency band of the wireless communications between the transmitting device and the receiving device.

18. The method of claim 1, wherein adjusting the size of the frame to be transmitted comprises setting the size of the frame at a value determined by using a relative speed between the transmitting device and the receiving device to perform a look up in a table of transmission frames sizes correlated to relative speeds between the transmitting device and the receiving device.

19. The method of claim 18, further comprising:
changing an operating frequency band to a first predetermined value in response to the relative speed not being in the table of transmission frames sizes and the operating frequency band being a second predetermined value.

20. The method of claim 1, further comprising:
determining, from one or more accelerometers on the transmitting device, an acceleration of the transmitting device; and
further adjusting an aggregated media access control packet data unit in response to the determined acceleration of the transmitting device exceeding an acceleration threshold value.

21. The method of claim 1, further comprising:
determining, from one or more accelerometers on the transmitting device, an acceleration of the transmitting device; and
further adjusting the size of the frame to be transmitted in response to the determined acceleration of the transmitting device exceeding an acceleration threshold value.

22. The method of claim 1, further comprising:
determining whether the size of the frame to be transmitted is a minimum value and whether the wireless communications between the transmitting device and the receiving device are set to a first operating frequency band value; and
changing an operating frequency band of the wireless communications to a second operating frequency band value in response to the size of the frame to be transmitted being the minimum value and the wireless communications being set to the first operating frequency band value.

23. An unmanned aerial vehicle (UAV), comprising:
a radio module configured to communicate with a receiving device; and
a processor coupled to the radio module and configured with processor-executable instructions to:
determine whether a potential degradation in reception of information within a frame to be transmitted due to relative motion of the UAV and the receiving device will equal or exceed a first packet error rate threshold value; and
adjust a size of the frame to be transmitted in response to determining that the potential degradation in the reception of information within the frame to be transmitted will equal or exceed the first packet error rate threshold value.

24. The UAV of claim 23, wherein the processor is further configured with the processor-executable instructions to:
adjust the size of the frame to be transmitted by at least one of:
reducing a number of sub-frames included within the frame;
reducing a size of sub-frames included within the frame; and
setting the size of the frame to be transmitted using information obtained from a data table in memory.

25. The UAV of claim 23, wherein the processor is further configured with the processor-executable instructions to:
determine whether packet error rates of an end portion of a previously transmitted frame are greater than a second packet error rate threshold value, wherein adjusting the size of the frame to be transmitted includes reducing the size of the frame to be transmitted in response to determining that the packet error rates of the end portion of the previously transmitted frame are greater than the second packet error rate threshold value.

26. The UAV of claim 23, wherein the processor is further configured with the processor-executable instructions to:
determine whether packet error rates of media access control packet data units (MPDUs) in an aggregated media access control packet data unit (AMPDU) are less than or equal to a third packet error rate threshold value, wherein adjusting the size of the frame to be transmitted includes increasing at least one of a number or a size of the MPDUs in the AMPDU to be transmitted in response to determining that packet error rates of MPDUs within an end portion of a previously transmitted AMPDU are less than or equal to the third packet error rate threshold value.

27. The UAV of claim 23, wherein the processor is further configured with the processor-executable instructions to determine whether the potential degradation in the reception of information within the frame to be transmitted due to the relative motion of the UAV and the receiving device will equal or exceed the first packet error rate threshold value by performing one of:
calculating a Doppler velocity between the UAV and the receiving device based upon a position of the receiving device that is stationary, the UAV's position, and a velocity vector of the UAV;
calculating the Doppler velocity between the UAV and the receiving device based upon the position of the UAV that is stationary, the position of the receiving device, and a velocity vector of the receiving device; or
calculating the Doppler velocity between the UAV and the receiving device based upon the position of the UAV and the velocity vector of the UAV and the position of the receiving device and the velocity vector of the receiving device, wherein both the UAV and the receiving device are moving independently of one another.

28. The UAV of claim 23, wherein the processor is further configured with the processor-executable instructions to:
calculate a distance between the UAV and the receiving device;
determine a relative speed between the UAV and the receiving device;
determine whether an operating frequency band of wireless communications between the UAV and the receiving device is set to a first predetermined value; and
change the operating frequency band to a second predetermined value in response to at least one of:
the distance between the UAV and the receiving device is less than a threshold distance, the determined relative speed is less than or equal to a threshold speed, and the operating frequency band is set to the first predetermined value, or
the distance between the UAV and the receiving device is greater than the threshold distance and the operating frequency band is set to the first predetermined value.

29. An unmanned aerial vehicle (UAV) comprising:
means for transmitting communications to a receiving device;
means for determining whether a potential degradation in reception of information within a frame to be transmitted due to relative motions of the UAV and the receiving device will equal or exceed a first packet error rate threshold value; and
means for adjusting a size of the frame to be transmitted in response to determining that the potential degradation in the reception of information within the frame to be transmitted will equal or exceed the first packet error rate threshold value.

30. A non-transitory processor-readable storage medium having stored thereon processor-executable instructions configured to cause a processor to perform operations for managing wireless communications between a transmitting device and a receiving device comprising:
determining whether a potential degradation in reception of information within a frame to be transmitted due to relative motion of the transmitting device and the receiving device will equal or exceed a first packet error rate threshold value; and
adjusting a size of the frame to be transmitted in response to determining that the potential degradation in the reception of information within the frame to be transmitted will equal or exceed the first packet error rate threshold value.
